(19) United States
(12) Patent Application Publication
(10) Pub. No.: US 2022/0066263 A1
(43) Pub. Date: Mar. 3, 2022

(54) BACKLIGHT AND LIQUID CRYSTAL DISPLAY DEVICE

(71) Applicant: 3M INNOVATIVE PROPERTIES COMPANY, St. Paul, MN (US)

(72) Inventors: Kazuhiko Toyooka, Higashine-shi (JP); Shingo Amari, Sagamihara-shi (JP); Sayaka Kado, Sagamihara-shi (JP); Kohei Kawahara, Sagamihara-shi (JP); Noboru Iwata, Sagamihara-shi (JP); Kazuhiko Minami, Higashine-shi (JP); Yukio Ishizuki, Tokyo (JP)

(21) Appl. No.: 17/310,144

(22) PCT Filed: Jan. 30, 2020
(86) PCT No.: PCT/IB2020/050753

§ 371 Date: Jul. 21, 2021

(30) Foreign Application Priority Data
Feb. 7, 2019 (JP) 2019-021018

(51) Int. Cl. G02F 1/1335; G02F 1/13357; G02F 1/1333

(52) U.S. Cl. CPC G02F 1/133536; G02F 1/133305; G02F 1/133615

(57) ABSTRACT

A backlight according to an embodiment includes a reflecting portion, a nonwoven fabric disposed opposing the reflecting portion, a reflective polarization portion disposed along a surface of the nonwoven fabric opposite to the surface of the nonwoven fabric opposing the reflecting portion, a side wall surrounding a cavity formed between the reflecting portion and the nonwoven fabric, and a light source disposed proximate the side wall and configured to illuminate light in the cavity, wherein a haze value of the nonwoven fabric is 90% or greater, an effective transmittance of the nonwoven fabric is 0.8 or greater, and a basis weight of the nonwoven fabric is 60 g/m² or greater.

### TECHNICAL FIELD

The present invention relates to a backlight and a liquid crystal display device.

### BACKGROUND

Conventionally, there is a surface light source device used as a backlight for a display device using, for example, a liquid crystal panel or the like.

### SUMMARY OF INVENTION

### Technical Problem

As a surface light source device including a light source on a side surface, a surface light source device generally includes a light source that emits light, a light guide plate configured to guide light incident on a back surface side or a side surface side from the light source and to emit the light from the front surface side, and a diffusion plate disposed on the front surface side of the light guide plate and allowing light incident from the light guide plate to diffuse to the front surface side. There is a problem in that, due to including a light guide plate, a weight of the surface light source device cannot be reduced, a light source device with a curved surface is difficult to design because a uniform surface light emission is difficult with using a curved light guide plate, a scratch and the like is caused by such as a dislocation of the light guide plate due to a vibration, and the like.

At the same time, there is a problem with a liquid crystal display device, which includes a light source on a back surface, in that a thickness of the surface light source device is increased in order to achieve the uniformity.

In JP 2013-25953 A (“Patent Document 1”), it is stated that “an aspect of the present invention is a surface light source device including a light source that emits light, a light guide plate configured to guide light incident on a back surface side or a side surface side from the light source and to emit the light from the front surface side, and a diffusion plate disposed on the front surface side of the light guide plate and allowing light incident from the light guide plate to diffuse to the front surface side, and the diffusion plate is made from a non-woven fabric having a basis weight of 10 to 40 g/m².” Patent Document 1 also states that “it is possible to obtain a uniform and emitted light with high luminance according to the invention”. In the surface light source device described, a light guide plate is essential to obtain a uniform and emitted light with high luminance.

A backlight according to one aspect of the present invention includes a reflecting portion, a nonwoven fabric disposed opposing the reflecting portion, a reflective polarization portion disposed along a surface of the nonwoven fabric opposite to the surface of the nonwoven fabric opposing the reflecting portion, a side wall surrounding a cavity formed between the reflecting portion and the nonwoven fabric, and a light source disposed proximate the side wall and configured to illuminate light in the cavity, wherein a haze value of the nonwoven fabric is 90% or greater, an effective transmittance of the nonwoven fabric is 0.8 or greater, and a basis weight of the nonwoven fabric is 60 g/m² or greater.

A liquid crystal display device according to one aspect of the present invention includes the backlight and a liquid crystal panel disposed on the light emitting surface side of the backlight.

According to one aspect of the present invention, a uniform and emitted light with high luminance is easily obtained with a simple structure.

### BRIEF DESCRIPTION OF DRAWINGS

FIG. 1 is a partial cutaway view illustrating the appearance of a backlight according to an embodiment of the present invention.

FIG. 2 is a cross-sectional view along line II-II illustrated in FIG. 1.

FIG. 3 is a cross-sectional view of a backlight according to another embodiment of the present invention.

FIG. 4 is a partial cutaway view illustrating the appearance of a backlight according to another embodiment of the present invention.

FIG. 5 is a cross-sectional view along a line V-V illustrated in FIG. 4.

FIG. 6 is a diagram illustrating an appearance of a liquid crystal display device according to an embodiment of the present invention.

FIGS. 7A to 7C are views illustrating manufacturing processes of side walls.

FIG. 8A is a schematic view illustrating an evaluation system according to the present example, and FIG. 8B is a diagram illustrating an observation image of the surface of the backlight.

FIG. 9A is a diagram illustrating the relationship between the height of the side wall and the uniformity of the surface of the backlight in Example 1. FIG. 9B is a diagram illustrating the relationship between the height of the side wall and the luminance of the surface of the backlight in Example 1.

FIG. 10A is a diagram illustrating the relationship between the height of the side walls and the uniformity of the surface of the backlight in Example 2, Example 3, and Comparative Example 3. FIG. 10B is a diagram illustrating the relationship between the height of the side walls and the luminance of the surface of the backlight in Example 2, Example 3, and Comparative Example 3.

FIGS. 11A and 11B are, respectively, views illustrating the observed images of the luminance of the backlight surface in Example 4 and Comparative Example 4.

FIG. 12 is a schematic view illustrating a structure of a prism sheet according to Example 5.

FIGS. 13A and 13B are, respectively, diagrams illustrating the surface luminance distribution and the angular luminance distribution of the backlight surface in Example 5. FIGS. 13C and 13D are, respectively, diagrams illustrating the surface luminance distribution and the angular luminance distribution of the backlight surface in Example 6. FIGS. 13E and 13F are, respectively, diagrams illustrating the surface luminance distribution and the angular luminance distribution of the backlight surface in Example 7.

### DESCRIPTION OF EMBODIMENTS

A backlight according to one aspect of an embodiment includes a reflecting portion, a nonwoven fabric disposed opposing the reflecting portion, a reflective polarization portion disposed along a surface of the nonwoven fabric opposite to the surface of the nonwoven fabric opposing the reflecting portion, a side wall surrounding a cavity formed between the reflecting portion and the nonwoven fabric, and a light source disposed proximate the side wall and configured to illuminate light in the cavity, wherein a haze value of the nonwoven fabric is 90% or greater, an effective transmittance of the nonwoven fabric is 0.8 or greater, and a basis weight of the nonwoven fabric is 60 g/m² or greater.

Light emitted from the light source repeatedly reflects within the cavity and enters the nonwoven fabric. In the nonwoven fabric, light is scattered and a portion of the light is emitted toward the reflective polarization portion. Of the light incident on the reflective polarization portion, only the light of one polarization component is emitted from the reflective polarization portion to the exterior of the backlight, and the light of the other polarization component is returned to inside the cavity. Here, since the basis weight of the nonwoven fabric is 60 g/m² or greater, light incident on the nonwoven fabric is moderately scattered. By being moderately scattered, light of the polarization component that can transmit the reflective polarization portion is emitted toward the reflective polarizing portion, and light from the light source can be brought out from the reflective polarization portion in an effective manner. In this backlight, since the haze value of the nonwoven fabric is 90% or greater, it is possible to obtain a uniformly emitted light in which a generation of a hot spot deriving from the light source is suppressed. In addition, since the effective transmittance of the nonwoven fabric is 0.8 or greater, an emitted light with high luminance can be obtained.

Furthermore, at least a portion of the backlight may be curved when viewed as a cross-section in a direction intersecting the nonwoven fabric. This allows a backlight also to adapt to a curved shape of a liquid crystal display device when the backlight is applied to the liquid crystal display device.

In addition, the cavity may have a flat shape, and, in the cavity, when a most distant first distance out of distances between the reflecting portion and the nonwoven fabric is set as H, and when a second distance is a distance along the reflecting portion and the second distance between the side wall portion proximate to which the light source is disposed and the side wall portion opposing the light source is set as Dp, Dp/H may be from 3 to 25. According to this configuration, a more uniform emitted light can be maintained at a higher luminance.

Further, the cavity may have a flat shape, may include a plurality of light sources disposed opposing to each other in the optical axis direction, and in the cavity, when a most distant first distance out of distances between the reflecting portion and the nonwoven fabric is set as H, and when a second distance is a distance along the reflecting portion and the second distance between the side wall portion proximate to which one of the light source is disposed and the side wall portion proximate to which the other of the light source is disposed is set as Dq, Dq/H may be from 6 to 50. According to this configuration, a more uniform emitted light can be maintained at a higher luminance.

Additionally, the reflecting portion may include a mirrored surface on the cavity side. This allows light emitted from the light source to be reflected in an effective manner within the cavity, facilitating the light to be easily emitted toward the nonwoven fabric without loss.

The side wall may also include an opposing surface opposing the light source, and at least a portion of the opposing surface may be a mirrored surface. This allows light emitted from the light source to be reflected in an efficient manner.

In the cavity, a distance between the reflecting portion and the nonwoven fabric may be substantially constant. This is advantageous for the uniformity of the light emitted from the nonwoven fabric.

Additionally, the nonwoven fabric and the reflective polarization portion may be bonded together. Integrating the nonwoven fabric and the reflective polarization portion by bonding makes them structurally robust.

A prism sheet may further be disposed between the nonwoven fabric and the reflective polarization portion, and the prism sheet may be bonded to the nonwoven fabric. Including the prism sheet is advantageous for increasing the luminance of the light emitted from the reflective polarizing portion, and since the prism sheet is bonded to the nonwoven fabric, it is easier to achieve a physically stable structure.

A liquid crystal display device according to one aspect of an embodiment includes a backlight and a liquid crystal panel disposed on the light emitting surface side of the backlight. According to this liquid crystal display device, a uniform and emitted light with high luminance is easier to obtain with a simple structure.

The backlight may be bonded to the liquid crystal panel. Integrating the backlight and the liquid crystal panel by bonding makes them structurally robust.

In the above embodiments, “surrounding the cavity” is not limited to an aspect in which the entire circumference of a cavity formed between the reflecting portion and the nonwoven fabric is surrounded, but an aspect is also included in which the cavity is surrounded with a space left in some part of the entire circumference. “To be disposed proximate a side wall” is not limited to an aspect of being disposed contacting a side wall, but an aspect of being disposed with a small distance from the side wall, such as less than 10 mm, is also included. A “flat shape” means a shape in which, a distance in a direction along the surface of the nonwoven fabric (a distance in the width direction) is greater than a distance between the reflecting portion and the nonwoven fabric (a distance in the height direction), and broadly includes a cross-sectional shape of a plate, a cross-sectional shape of a block, a cross-sectional shape of an ellipse, and the like. “Substantially constant” means an error of ±10% may be included. “Bonding” includes both a bonding by lamination using adhesives such as a pressure sensitive adhesive, and a bonding by lamination using a bonding agent.

Detailed descriptions of the embodiments are given below with reference to the attached drawings. Note that, in the description of the drawings, identical or equivalent elements are denoted using the same reference numerals, and duplicate descriptions thereof are omitted. In the present embodiment, the X, Y, and Z axes are conveniently set in the drawings for subsequent description.

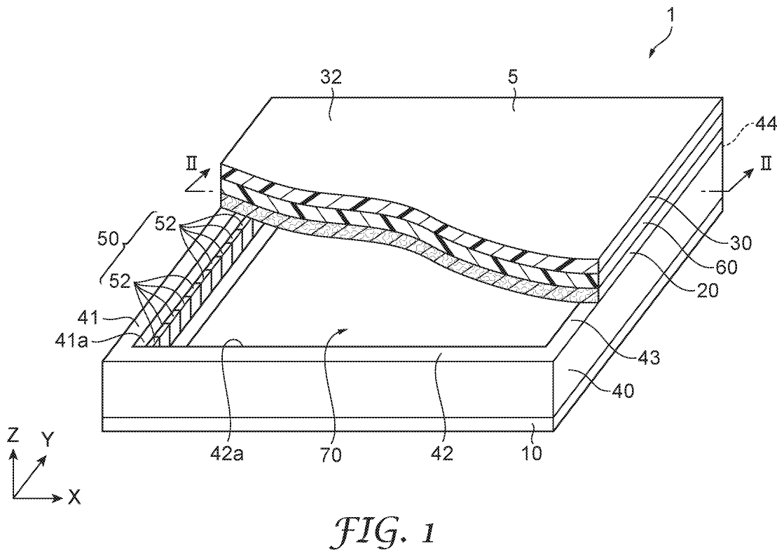

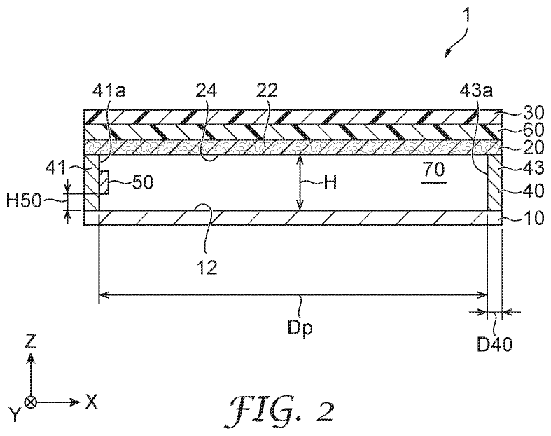

FIG. 1 is a partial cut-away view illustrating the appearance of a backlight according to an embodiment of the present invention. FIG. 2 is a cross-sectional view along line II-II in FIG. 1. As illustrated in FIG. 1 and FIG. 2, backlight 1 includes a reflecting portion 10, a nonwoven fabric 20, a reflective polarization portion 30, side walls 40, and a light source 50. If desired, backlight 1 further includes a prism sheet 60, and the prism sheet 60 is disposed between the nonwoven fabric 20 and the reflective polarization portion 30, for example. In the present embodiment, the reflecting portion 10, the nonwoven fabric 20, the prism sheet 60, and the reflective polarization portion 30 can be arranged in this order. In FIG. 1, the nonwoven fabric 20, the prism sheet 60, and the reflective polarization portion 30 are illustrated with part of them broken.

The reflecting portion 10 is disposed opposing the nonwoven fabric 20. The reflecting portion 10 includes a reflective surface 12, and the nonwoven fabric 20 includes a top surface 22 and a bottom surface 24. The reflective surface 12 of the reflecting portion 10 opposes the bottom surface 24 of the nonwoven fabric 20. A cavity 70 is formed between the reflecting portion 10 and the nonwoven fabric 20, and the cavity 70 is surrounded by side walls 40. The cavity 70 is a light guide space consisting essentially of air only. Therefore, while light from the light source 50 is guided within the cavity 70, no member such as a light guide plate is included in the cavity 70.

In backlight 1, light from the light source 50 is emitted toward the nonwoven fabric 20, and the light that has passed through the nonwoven fabric 20 is emitted to the exterior of the backlight 1 through the optionally provided prism sheet 60 and the reflective polarization portion 30. The reflecting portion 10 and the side walls 40 may cause the light that has not directly headed from the light source 50 to the nonwoven fabric 20, to be reflected toward the nonwoven fabric 20.

The reflective surface 12 of the reflecting portion 10 can be a mirrored surface. In the present embodiment, a mirrored surface has a specular reflectivity of 80% or greater and is distinguished from a rough surface. The reflective surface 12 can be constituted by a plate-like member made of a resin deposited with a thin metal film such as silver or aluminum, a reflective film of a dielectric having a super multilayer structure, or the like. The reflective surface 12 may also be constituted by a resin plate colored white, or a metal plate made from aluminum or the like. The reflecting portion 10, being capable of reflecting light from the light source 50 toward the nonwoven fabric 20, reflects the light emitted from the light source 50 within the cavity 70 in an effective manner, such that the light is easily emitted without loss toward the nonwoven fabric 20.

The side wall 40 is formed of four side wall portions, for example. The side wall 40 includes a first side wall portion 41, a second side wall portion 42, a third side wall portion 43, and a fourth side wall portion 44, and for example, the first side wall portion 41 is opposing the third side wall portion 43 and the second side wall portion 42 is opposing the fourth side wall portion 44. The side wall 40 includes, for example, a resin such as polypropylene, polycarbonate, polyethylene, polyester, and polyvinyl chloride, a metal such as aluminum, and stainless steel, and the like.

A light source 50 is disposed proximate to the side wall 40 and is arranged to irradiate light into the cavity 70. The light 50 is provided proximate at least one of the first side wall portion 41, the second side wall portion 42, the third side wall portion 43, and the fourth side wall portion 44. In the present embodiment, the first side wall portion 41 includes a first inner surface 41a facing the cavity 70, and the light source 50 can be provided on the first inner surface 41a. Note that the second side wall portion 42 includes a second inner surface 42a facing the cavity 70, and the light source 50 may be provided on the second inner surface 42a.

When the light source 50 is provided on the first inner surface 41a of the first side wall portion 41, the third side wall portion 43 includes an opposing surface 43a opposing the light source 50. When the light source 50 is provided on the second inner surface 42a of the second side wall portion 42, the fourth side wall portion 44 includes an opposing surface opposing the light source 50. The opposing surface opposing the light source 50 means a surface that intersects an optical axis when the optical axis of the light source 50 is assumed. At least a portion of the opposing surface opposing the light source 50 may be a mirrored surface. The opposing surface of the side wall 40 can be constituted by a plate-like member made of a resin deposited with a thin metal film, a reflective film of a dielectric having a super multilayer structure, a white resin plate, or a metal plate such as aluminum.

The light source 50 includes one or more optical elements 52 and may be arranged on the side wall 40 at a first spacing H50 from the reflective surface 12. The light source 50 may include a row of optical elements 52 and may include a plurality of rows of optical elements 52. The optical elements 52 may be arranged in rows on the side wall 40 at a constant spacing or may be arranged on the side wall 40 at irregular intervals. In the present embodiment, the first spacing H50 may have a constant value or may have varying values. The optical element 52 includes, for example, a LED (a light emitting diode) and a fluorescent tube.

Note that it suffices that the light source 50 is disposed proximate to the side wall 40 to be able to emit light into the cavity 70, and not limited to be on the inner surface of the side wall portion. In addition, the side wall 40 may be provided bulging outward from the reflecting portion 10 in a direction along the reflecting portion 10, and the light source 50 may be disposed proximate to the side wall 40 outwardly provided from the reflecting portion 10.

Although FIG. 1 and FIG. 2 illustrate an example where the light source 50 is disposed on the first side wall portion 41, that is, in contact with the first side wall portion 41, the light source 50 may be disposed being spaced at a small distance from the first side wall portion 41. The small distance from the first side wall portion 41 is 5 mm to 10 mm, for example.

The nonwoven fabric 20 is provided defining a part of the cavity 70 together with the reflecting portion 10, and forms, for example, a plate-like shape. Light from the light source 50 is diffused by the nonwoven fabric 20 toward the optionally provided prism sheet 60 and the reflective polarization portion 30.

The nonwoven fabric 20 includes, for example, a general-purpose plastic such as polyethylene, polypropylene, and polyethylene terephthalate, or a resin such as engineering plastic such as polybutylene terephthalate, and polyphenylene sulfide.

The haze value of the nonwoven fabric 20 is 90% or greater. The haze value can be 98% or greater. The haze value is measured by a method conforming to JIS K 7136 (2000), for example.

In the present embodiment, the effective transmittance of the nonwoven fabric 20 is 0.80 or greater. Further, the effective transmittance can be 0.81 or greater. The effective transmittance of the nonwoven fabric 20 may be 1.0 or less. The basis weight of the nonwoven fabric 20 is 60 g/m² or greater. The basis weight can be 75 g/m² or greater, and the basis weight can be 80 g/m² or greater. The basis weight of the nonwoven fabric 20 is 300 g/m² or less. The basis weight of the nonwoven fabric 20 may be 250 g/m² or less.

The reflective polarization portion 30 can be a plate-like member configured to include at least two polymer layers. The reflective polarization portion 30 transmits light of a first polarization state, for example, p-polarized light, based on the refractive index difference between each polymer layer while reflecting light of a second polarization state, for example, s-polarized light, that is substantially orthogonal to the first polarization state, toward the nonwoven fabric 20. As, in the nonwoven fabric 20, light from the reflective polarization portion 30 is again scattered by the nonwoven fabric 20 and undergoes a change in the polarization state, as a result, some of the light returned from the nonwoven fabric 20 to the reflective polarization portion 30 can be a p-polarized light, and thus passes through the reflective polarization portion 30. Light passing through the reflective polarization portion 30 is emitted to the outside from the light emitting surface 5 of the backlight 1. The light emitting surface 5 of the backlight 1 is the same surface as the top surface 32 of the reflective polarization portion 30 and is located at the top of the backlight 1.

At least one layer of the polymer layer of the reflective polarization portion 30 has, for example, naphthalate functionality. This naphthalate functionality is incorporated into the polymer layer by polymerizing one or more monomers including naphthalate functionality. Monomers including naphthalate functionality, for example, include naphthalate and esters thereof such as 2,6-, 1,4-, 1,5-, 2,7-, 2,3-naphthalene dicarboxylic acid. In addition, at least one of the polymer layers includes polyethylene naphthalate (PEN), which is a copolymer of 2,6-, 1,4-, 1,5-, 2,7- and/or 2,3-naphthalene dicarboxylic acid and ethylene glycol, for example.

The reflective polarization portion 30 may be bonded to the nonwoven fabric 20. Integrating the reflective polarization portion 30 and the nonwoven fabric 20 by bonding makes the backlight 1 structurally robust.

The prism sheet 60 is, if necessary, a sheet-like member disposed between the nonwoven fabric 20 and the reflective polarization portion 30 and is formed by a material having excellent light transmittance, for example. The top or bottom surface of the prism sheet 60 includes a plurality of arranged prisms, and these prisms align the emitting direction of light that has passed through the nonwoven fabric 20. Or, these prisms cause emitting direction of light to be changed that has passed through the nonwoven fabric 20.

Specifically, the prism sheet 60 includes a first polymeric layer including a top surface of a microstructure and a second polymeric layer disposed on the opposite side of the top surface of the microstructure, for example. For example, the top surface of the microstructure includes a plurality of arranged prisms. The plurality of arranged prisms can maintain or change a travelling direction of light incident on the prism by the function of refraction and total reflection of light. A portion of the light incident on the prism maintains its travelling direction and is headed toward the reflective polarization portion 30. The other portion of the light undergoes a change in its travelling direction and is returned to the nonwoven fabric 20. The light returned to the nonwoven fabric 20 is again scattered and diffused by the nonwoven fabric, loss from which being small. Such scattered and diffused light is reflected by the reflecting portion 10 and the side wall 40 and can enter the prism sheet 60 by passing through the nonwoven fabric 20 again. As a result, the amount of light headed from the nonwoven fabric 20 to the reflective polarization portion 30 is increased, and the luminance of the reflective polarization portion 30 can be more effectively increased. Providing the prism sheet 60 is advantageous for increasing the luminance of light emitted from the reflective polarization portion 30.

The prism sheet 60 may be bonded to the nonwoven fabric 20. Since the prism sheet 60 is bonded to the nonwoven fabric 20, a physically stable structure of the backlight 1 is more easily achieved. Note that the reflective polarization portion 30 may be provided between the nonwoven fabric 20 and the prism sheet 60.

In backlight 1, light emitted from the light source 50 is repeatedly reflected within cavity 70 and enters the nonwoven fabric 20. In the nonwoven fabric 20, light is scattered, and a portion of the light is emitted toward the reflective polarization portion 30. Of the light incident on the reflective polarization portion 30, only the light of one polarization component is emitted from the reflective polarization portion 30 to the exterior of the backlight 1, and the light of the other polarization component is returned to inside the cavity 70. Here, since the basis weight of the nonwoven fabric 20 is 60 g/m² or greater, light incident on the nonwoven fabric 20 is moderately scattered. By being moderately scattered, light of the polarization component that can transmit the reflective polarization portion 30 is emitted toward the reflective polarizing portion 30, and light from the light source 50 can be brought out from the reflective polarization portion 30 in an effective manner. In this backlight 1, since the haze value of the nonwoven fabric 20 is 90% or greater, it is possible to obtain a uniformly emitted light in which a generation of a hot spot deriving from the light source 50 is suppressed. In addition, since the effective transmittance of the nonwoven fabric 20 is 0.8 or greater, an emitted light with high luminance can be obtained.

The cavity 70 is formed between the reflecting portion 10 and the nonwoven fabric 20 and can form a flat shape. Being formed in a flat shape, the cavity 70 has a shape in which its distance in the direction along the bottom surface 24 of the nonwoven fabric 20, in other words, a distance in the width direction (Y-axis direction) is larger than the distance between the reflecting portion 10 and the nonwoven fabric 20, in other words, the distance in the height direction (the Z axis direction). An example is illustrated in FIG. 1 and FIG. 2, in which the cavity 70 has a cross-sectional shape of a plate or a cross-sectional shape of a block, but the cavity 70 may have a cross-sectional shape of an ellipse, a cross-sectional shape of a fan, or a cross-sectional shape of a semi-cylindrical shape, for example.

As illustrated in FIG. 2, the cavity 70 has distances corresponding to the height between the reflecting portion 10 and the nonwoven fabric 20. Of these distances, the most distant distance is the first distance H. In addition, the cavity 70 has corresponding distances in the width direction along the reflecting portion 10. Of these distances, the distance between a first side wall portion 41 proximate to which the light source 50 is disposed and a third side wall portion 43 opposing the light source 50 is the second distance Dp.

In the present embodiment, H/Dp obtained by dividing the first distance H by the second distance Dp may be from 3.0 to 25. According to this configuration, a more uniform emitted light can be maintained at a higher luminance. In the present embodiment, H/Dp may be 3.5 or greater and 24 or less. According to this configuration, a more uniform emitted light can be further maintained at a higher luminance.

In the cavity 70, the distance between the reflecting portion 10 and the nonwoven fabric 20 may be substantially constant. In this case, this is advantageous for the uniformity of the light emitted from the nonwoven fabric 20.

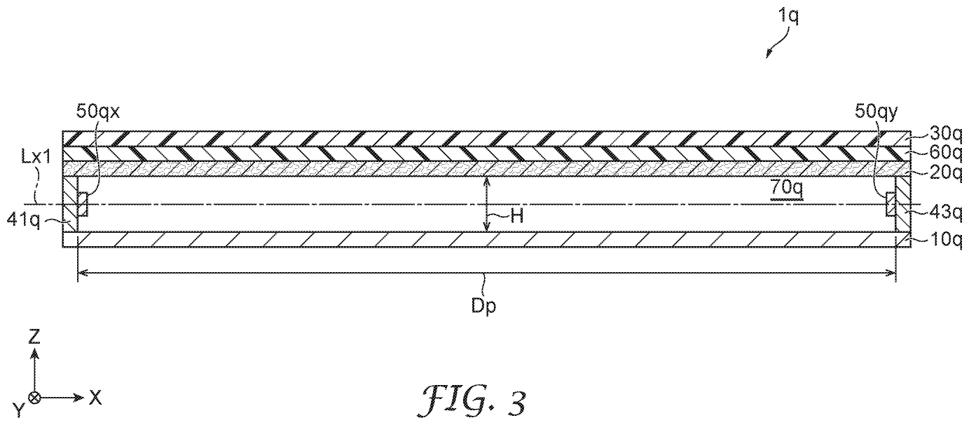

FIG. 3 is a cross-sectional view of a backlight according to another embodiment of the present invention, corresponding to the cross-sectional view of FIG. 2. A cavity 70q according to the present embodiment is formed between a reflecting portion 10q and a nonwoven fabric 20q, and can form a flat shape. In addition, the cavity 70q includes a plurality of light sources 50qx, 50qy disposed opposing each other in the direction of an optical axis Lx1. In the backlight 1q according to the present embodiment, one light source 50qx is provided on a first side wall portion, and the other light source 50qy is provided on a third side wall portion 43q opposing the first side wall portion 41q. The light source 50qx provided on the first side wall portion 41q is opposing in the direction of the optical axis Lx1 to the light source 50qy provided on the third side wall portion 43q.

As illustrated in FIG. 3, the cavity 70q has distances corresponding to the height between the reflecting portion 10q and the nonwoven fabric 20q. Of these distances, the most distant distance is the first distance H. In addition, the cavity 70q has corresponding distances in the width direction along the reflecting portion 10q. Of these distances, the distance between the first side wall portion 41q proximate to which one light source 50qx is disposed, and the third side wall portion 43q proximate to which the other light source 50qy which is opposing the one light source 50qx is disposed, is the second distance Dq.

In the present embodiment, H/Dq obtained by dividing the first distance H by the second distance Dq may be from 6 to 50. According to this configuration, a more uniform emitted light can be maintained at a higher luminance. In the present embodiment, H/Dq may be 7 to 48. According to this configuration, a more uniform emitted light can be further maintained at a higher luminance. In the cavity 70q, the distance between the reflecting portion 10q and the nonwoven fabric 20q may be substantially constant. This is advantageous for the uniformity of the light emitted from the nonwoven fabric 20q.

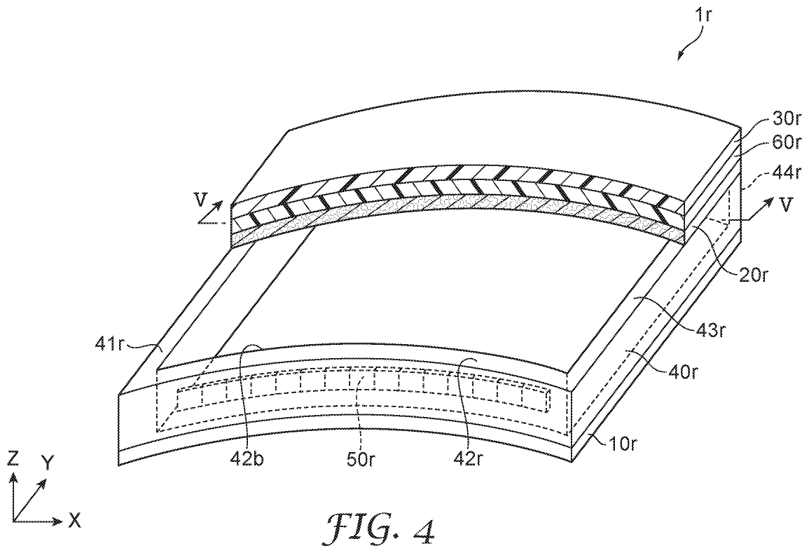

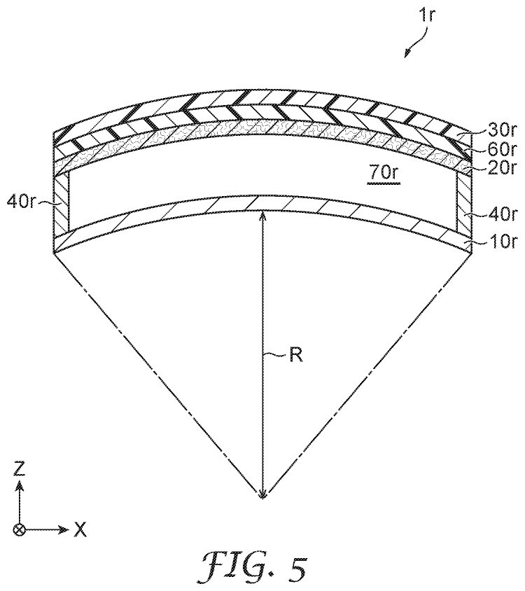

FIG. 4 is a partial cutaway view illustrating the appearance of a backlight according to another embodiment of the present invention. FIG. 5 is a cross-sectional view along line V-V in FIG. 4. The backlight 1r in FIG. 4 and FIG. 5 includes a reflecting portion 10r, a nonwoven fabric 20r, a reflective polarization portion 30r, side walls 40r, and a light source 50r, similarly to the backlight 1r of FIG. 1 and FIG. 2. If desired, the backlight 1r further includes a prism sheet 60r, and the prism sheet 60r is disposed between the nonwoven fabric 20r and the reflective polarization portion 30r, for example. In the present embodiment, too, the reflecting portion 10r, the nonwoven fabric 20r, the prism sheet 60r, and the reflective polarization portion 30r can be arranged in this order. In FIG. 4, the nonwoven fabric 20r, the prism sheet 60r, and the reflective polarization portion 30r are illustrated with part of them broken.

In the backlight 1r of FIG. 4 and FIG. 5, the light source 50r may be provided on the second inner surface 42b of the second side wall portion 42r. When the light source 50r is provided on the second inner surface 42b of the second side wall portion 42r, the fourth side wall portion 44r includes an opposing surface opposing the light source 50r. The backlight 1r, apart from including a light source 50r on the second inner surface 42b of the second side wall portion 42r and the entire backlight being curved when viewed as a cross section in a direction intersecting the nonwoven fabric 20r, is constituted by each part, namely, the reflecting portion 10r, the nonwoven fabric 20r, the prism sheet 60r, and the reflective polarization portion 30r, similarly configured and including similar materials as each part in the backlight 1 of FIG. 1 and FIG. 2.

In the backlight 1r, too, light from the light source 50r is emitted toward the nonwoven fabric 20r, and the light that has passed through the nonwoven fabric 20r is emitted to the exterior of the backlight 1r through the optionally provided prism sheet 60r and the reflective polarization portion 30r. The reflecting portion 10r and the side walls 40r may cause the light that has not directly headed from the light source 50r to the nonwoven fabric 20r, to be reflected toward the nonwoven fabric 20r.

At least a portion of the backlight 1r may be curved when viewed as a cross-section in a direction intersecting the nonwoven fabric 20r, and at least a portion of the backlight 1r may be curved in a cross section in the XZ plane, for example. As illustrated in FIG. 5, in the present embodiment, the backlight 1 may have a shape convex upward as a whole with a radius of curvature R. The radius of curvature R is, for example, 500 mm or greater. In the present embodiment, the backlight 1r may have a shape convex upward as a whole with a radius of curvature R. Besides this, at least a portion of the backlight 1r may be curved, for example, in a cross-section in the YZ plane, or, for example, at least a portion of the backlight 1r may be curved in cross sections both in the XZ plane and in the YZ plane.

Since at least a portion of the backlight 1r may be curved when viewed as a cross-section in a direction intersecting the nonwoven fabric 20r, when the backlight 1r is applied to the liquid crystal display device the backlight 1r can be adapted to a curved shape of the liquid crystal display device.

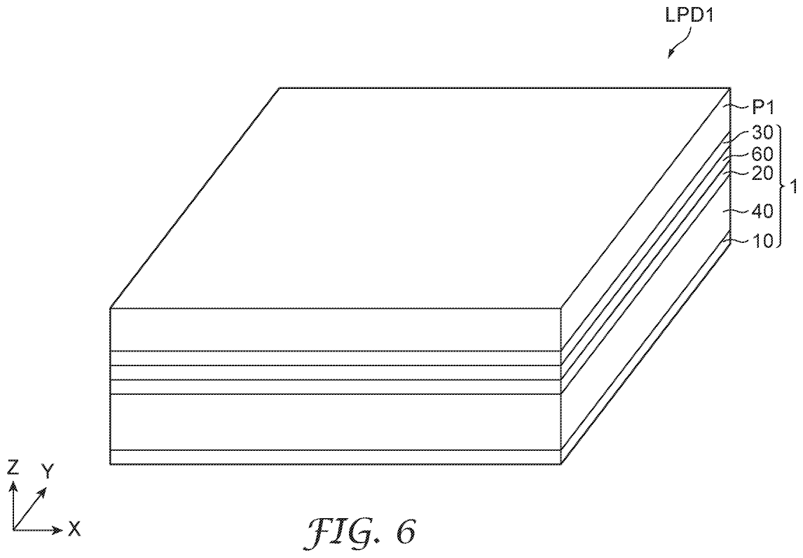

FIG. 6 is a diagram illustrating an appearance of a liquid crystal display device in accordance with an embodiment of the present invention. The liquid crystal display device LPD1 includes, for example, a backlight 1 according to the embodiment illustrated in FIG. 1, and a liquid crystal panel P1. In the liquid crystal display device LPD1, the liquid crystal panel P1 is disposed on the light emitting surface 5 side of the backlight 1. The liquid crystal panel P1 includes a panel in which a linear polarizing plate or the like is fixed to a surface of a liquid crystal cell such as TFT, STN, IPS, and VA. The liquid crystal cell includes, for example, a plurality of substrates, an electrode provided for each substrate, a liquid crystal layer encapsulated between each substrate, an alignment film, a spacer, a color filter, and the like.

In this liquid crystal display device LPD1, a uniform and emitted light with high luminance is easier to obtain with a simple structure.

Note that the liquid crystal display device LPD1 may be provided with the backlight 1q according to the embodiment illustrated in FIG. 3, or may be provided with the backlight 1r as illustrated in FIG. 4 and FIG. 5. In an embodiment provided with the backlight 1r, the liquid crystal panel P1 has a shape that matches the curved shape of the backlight 1r.

The backlight 1 may be bonded to the liquid crystal panel P1. Integrating the backlight 1 and the liquid crystal panel P1 together by bonding makes them structurally robust.

### EXAMPLES

The backlight and liquid crystal display device will be described further below using examples and comparative examples of the present invention. The present invention is not limited to the following examples:

### Example 1

### Manufacturing of Backlight

Backlight 1 of the present example includes a side wall and a top film layer. The side wall was manufactured using a FOREX (trade name, manufactured by Acrysunday) white vinyl chloride plate. The thickness of the vinyl chloride plate was 1 mm. The two-dimensional shape of the vinyl chloride plate was rectangular.

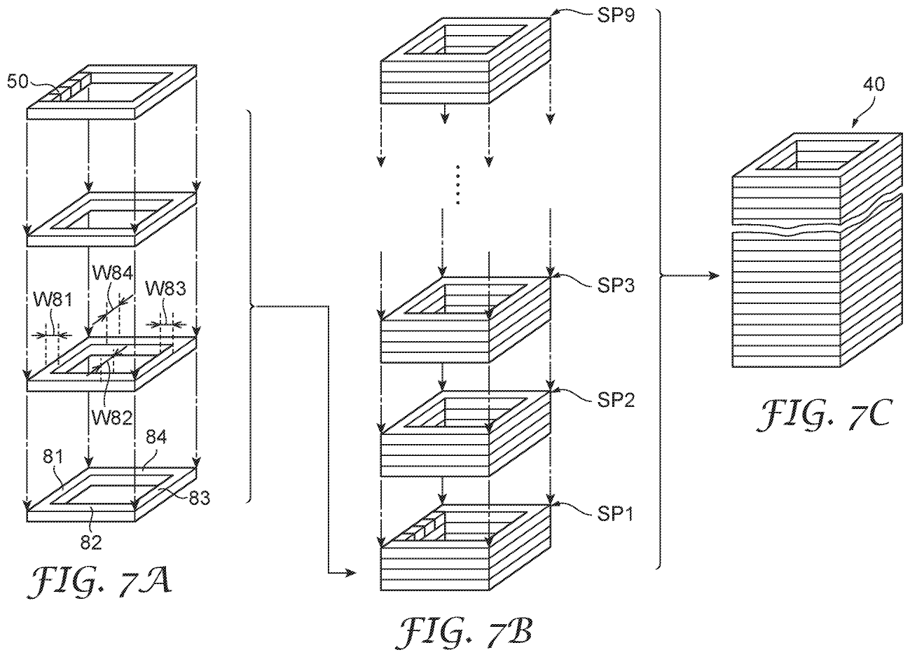

FIGS. 7A to 7C are diagrams illustrating the step of manufacturing the side wall. Firstly, as illustrated in FIG. 7A, each of the vinyl chloride plates was cut out leaving their edge portions only. In the present example, each of the cut vinyl chloride plates includes four edges, which are, a first edge 81, a second edge 82, a third edge 83, and a fourth edge 84. The first edge 81 is opposing the third edge 83, and the second edge 82 is opposing the fourth edge 84. The edge width W81 of the first edge 81 was made to be 6 mm, and the edge width of the second edge W82 was made to be 2 mm. The edge width W83 of the third edge 83 was made to be 4 mm, and the edge width of the fourth edge W84 was made to be 2 mm. The thickness of the four edges was all 1 mm. The distance between the inner side of the first edge 81 and the inner side of the third edge 83 was made to be 150 mm, and the distance between the inner side of the second edge 82 and the inner side of the fourth edge 84 was made to be 98 mm.

As illustrated in FIG. 7B, in the present example, four of each of the cut vinyl chloride plates were laminated together, and a high reflection film ESR-80v2 (manufactured by 3M) was adhered to their inner side using a double-sided tape to form a first side wall laminate SP1. Each vinyl chloride plate was bonded to each other by a double-sided tape. In the first side wall laminate SP1, out of each of the cut vinyl chloride plates, one vinyl chloride plate was not provided the first edge 81 such that the vinyl chloride plate was cut in a so-called U shape. Then the light source 50, that is, an array of LEDs, was inserted at the location of the first edge 81. The array of LEDs was installed being able to irradiate light toward the inside of the cut vinyl chloride plate. The thickness of the first side wall laminate SP1 was 4 mm.

In the present example, four of each of the cut vinyl chloride plates were laminated together to form a second side wall laminate SP2. In the second side wall laminate SP2, all of the cut vinyl chloride plates include a first edge 81, a second edge 82, a third edge 83, and a fourth edge 84. In the present example, seven of the side wall laminates (SP3 to SP9) similar to the second side wall laminate SP2 were additionally formed. As illustrated in FIGS. 7B and 7C, each side wall laminate (SP3 to SP9) was sequentially laminated, and the high reflection film ESR-80v2 (manufactured by 3M) was adhered to the inside of the side wall laminate using a double-sided tape.

When the side wall 40 only included the first side wall laminate SP1, the height of the side wall 40 was 4 mm. When the side wall 40 included the first side wall laminate SP1 and the second side wall laminate SP2 disposed above the first side wall laminate SP1, the height of the side wall 40 was 8 mm. Hereinafter, similarly, when the side wall 40 included the first side wall laminate SP1, the second side wall laminate SP2, and the third side wall laminate SP3, the height of the side wall 40 was 12 mm. When all of the nine side wall laminates formed in the present example were stacked, the height of the side wall 40 was 36 mm. The side wall 40 was configured to include the first side wall laminate SP1 at all times.

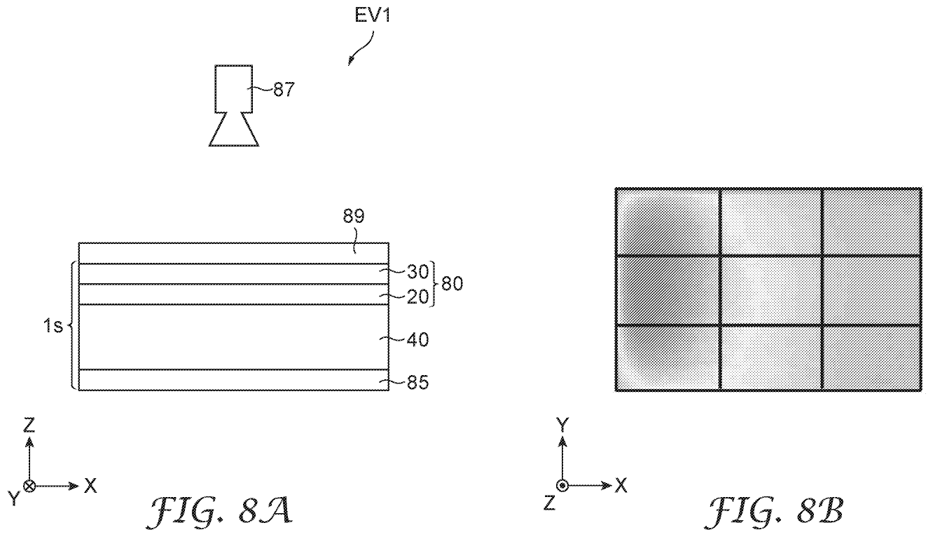

As the reflective surface 12, a bottom surface portion 85 was used, which is formed by installing, on the inner bottom surface of a metal housing of a commercially available liquid crystal display, a high reflection film ESR-80v2 (manufactured by 3M) of the same size (see FIG. 8A). The liquid crystal display used was a 7-inch size LCD7620 (manufactured by ADTECHNO).

### Formation of Upper Film Layer

As illustrated in FIG. 8A, the top film layer 80 of the present example includes a nonwoven fabric 20 and a reflective polarizing portion 30. The nonwoven fabric 20 was disposed on the side wall 40 and the reflective polarization portion 30 was disposed on the nonwoven fabric 20. For the nonwoven fabric 20, a diffusion film EFD-D2-85 (manufactured by 3M) was used, and for the reflective polarization section 30, a reflective polarizing film DBEF-Qv2 (manufactured by 3M) was used. The basis weight of the nonwoven fabric EFD-D2-85 was 85 g/m².

### Evaluation System

In the present example, the uniformity and luminance of the surface of the backlight 1s were evaluated. In the present example, the surface of the reflective polarization portion 30 was evaluated.

FIG. 8A is a schematic diagram illustrating an evaluation system according to the present example. In the present example, an evaluation system 87 including a two-dimensional color luminance meter CA-2500 (manufactured by Konica Minolta) was installed above the backlight 1s, and the surface of the backlight 1s was observed.

The evaluation system EVI includes a viewing polarizer 89, which is provided between the two-dimensional color luminance meter 87 and the backlight 1s, and in the present example, the viewing polarizer 89 was disposed on the backlight 1s. The polarization direction of the viewing polarizer 89 was configured to be the same direction as the polarization direction of the reflective polarization portion 30.

### Evaluation of Uniformity

FIG. 8B is a diagram illustrating an observed image of the surface of the backlight. This observed image was obtained by a two-dimensional color luminance meter CA-2500. In the present example, the observed image of the surface of the backlight 1s was divided into nine divisions. Specifically, the division was made into three divisions along a direction of one side (the X-axis direction) of the surface of the backlight 1s, and the division was also made into three divisions along the direction of the other side (the Y-axis direction) intersecting the above direction. In the present example, the luminance at the center point of each of the nine divided areas was measured.

In the present example, of the luminance at the center point of each area measured, that is, the nine luminance values, the highest luminance was defined as LUM1 and the lowest luminance was defined as LUM2. Subsequent to this, the uniformity (%) of the surface of the backlight is was defined as in Formula (1) below.

Uniformity (%)=LUM2/LUM1 (1)

### Evaluation of Luminance

Evaluation of luminance were made by measuring the luminance at the center point of the entire surface of the observation image of the surface of the backlight as illustrated in FIG. 8B, and that luminance was defined as the luminance of the surface of the backlight.

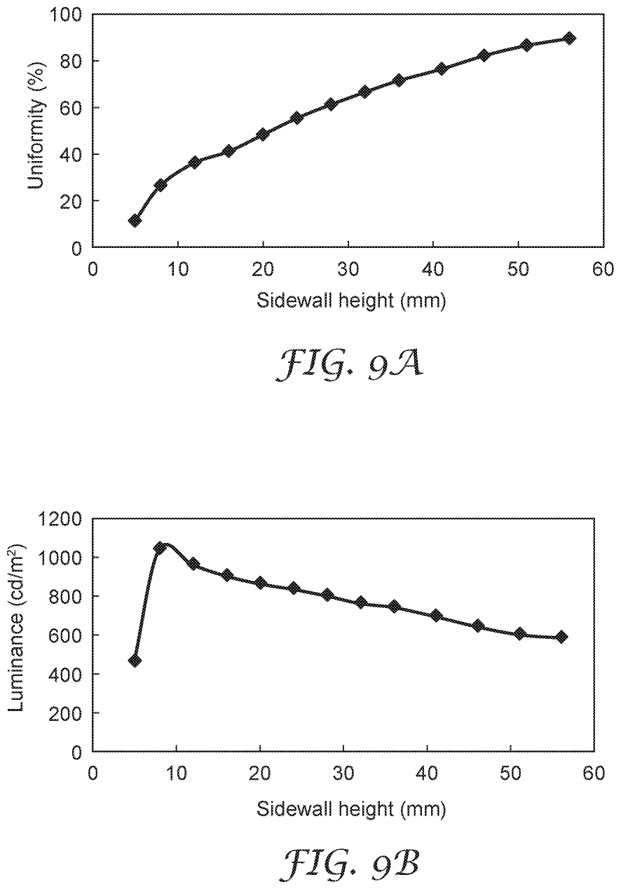

FIG. 9A is a diagram illustrating the relationship between the height of the side wall and the uniformity of the surface of the backlight in Example 1. FIG. 9B is a diagram illustrating the relationship between the height of the side wall and the luminance of the surface of the backlight in Example 1. In FIGS. 9A and 9B, the distance between the first edge 81 and the third edge 83 was configured to be 150 mm. Therefore, the second distance Dq between the first edge 81 (corresponding to the first side wall portion 41) on which the light source 50 is disposed and the third edge 83 (corresponding to the third side wall portion 43) opposing the light source 50 is 150 mm. As illustrated in FIG. 9B, when the first distance H between the reflecting portion 10 and the nonwoven fabric 20, that is, the height of the side wall is 6 mm to 50 mm, the luminance of the surface of the backlight was 600 cd/m² or greater.

### Comparative Example 1

In the present comparative example, a backlight was prepared in the same manner as in Example 1. The backlight of the present comparative example has the same configuration as the backlight of Example 1 except that the configuration of the top film layer is different from the configuration of the top film layer of Example 1.

The top film layer of the present comparative example includes an EFD-D2-85 as the nonwoven fabric 20, while including no reflective polarization portion 30. In the present comparative example, the uniformity and luminance of the surface of the backlight were evaluated in the same manner as in Example 1.

### Comparative Example 2

In the present comparative example, a backlight was prepared in the same manner as in Example 1. The backlight of the present comparative example has the same configuration as the backlight of Example 1 except that the configuration of the top film layer is different from the configuration of the top film layer of Example 1.

The top film layer of the present comparative example includes a DBEF-Qv2 as the reflective polarization portion 30 while including no nonwoven fabric 20. In the present comparative example, the uniformity and luminance of the surface of the backlight were evaluated in the same manner as in Example 1.

Table 1 is a table showing the backlight configurations in Example 1, Comparative Example 1, and Comparative Example 2 and the evaluation results of the uniformity and luminance of the surface of the backlight. The evaluation results of the uniformity and luminance of the surface of the backlight in Table 1 are obtained when the side wall 40 includes the first side wall laminate SP1 and the second side wall laminate SP2 in all of Example 1, Comparative Example 1, and Comparative Example 2. The thickness of the side wall 40 was 8 mm.

TABLE 1

| | | | Comparative |
|---|---|---|---|
| | | Comparative | Example |
| | Example 1 | Example 1 | 2 |
| Top film layer | Reflective | — | Reflective |
| | polarizer | | polarizer |
| | (DBEF-Qv2) | | (DBEF-Qv2) |
| | Nonwoven fabric | Nonwoven fabric | — |
| | (EFD-D2-85) | (EFD-D2-85) | |
| Uniformity (%) | 29.59 | 10.69 | 8.44 |
| Luminance | 402 | 365 | 87 |
| (cd/m²) | | | |

### Example 2

In the present example, a backlight was prepared in the same manner as in Example 1. The backlight of the present example has a configuration similar to that of the backlight of Example 1.

In the present example, the uniformity and luminance of the surface of the backlight were evaluated in the same manner as in Example 1. In addition, in the present example, a hot spot was observed and effective transmittance (gain) and haze value were measured.

### (Observation of Hot Spots)

The surface of the backlight was observed to see if a hot spot deriving from a LED of the light source was observed. If no hot spots were observed, it was evaluated as “good (A)”, and if a hot spot was observed, it was evaluated as “poor (B)”.

### (Measurement of Haze Value)

In the present example, the haze value of the nonwoven fabric 20 was measured. This measurement was performed using a haze meter NDH2000 (manufactured by Nippon Denshoku Industries) based on a method conforming to JISK7136 (2000). The light source was a D65 light source. The measurement was performed three times, and the average value was taken as the haze value.

### (Measurement of Effective Transmittance)

The effective transmittance was measured using a spectral colorimeter PR-650 (manufactured by Photo Research), a polarization unit P/N 03FPG007 (manufactured by Melles Griot), a 6.35 mm thickness Teflon (trade name) diffusion plate direct type light box, and a light source device DCRIIw (manufactured by Fostec). The single transmittance in the polarization unit P/N 03FPG007 was 32%, and the parallel Nicol transmittance was 20% or higher. In the lamp EKE of the light source DCRIIw, the applied voltage was 21 V and the power was 150 W.

The effective transmittance was obtained by the following equation (2): Assuming that the emission spectrum of the light box is LLB(λ) and the emission spectrum when the sample is placed in the light box is Lₛₐₘₚₗₑ(λ), the transmittance Tₛₐₘₚₗₑ(λ) is given by the following equation (2):

Tₛₐₘₚₗₑ(λ)=Lₛₐₘₚₗₑ(λ)/L_{LB}(λ) (2)

Further, L_{BL-sample}(λ) which is the emission spectrum of backlight when the sample is placed in the light box is obtained by the following equation (3):

L_{BL-sample}(λ)=L_{LB}(λ)×Tₛₐₘₚₗₑ(λ) (3)

Additionally, when the correction term is V(λ), the backlight luminance Bₛₐₘₚₗₑ when the sample is placed in the light box is given by Equation (4) below.

Bₛₐₘₚₗₑ=∫V(λ)·L_{BL-sample}(λ) (4)

Further, the backlight luminance BBL is calculated by the following equation (5).

B_{BL}=∫V(2)·L_{LB}(λ) (5)

From the equations (4) and (5) above, the effective transmittance is obtained from the following formula (6).

Effective transmittance=Bₛₐₘₚₗₑ/B_{BL} (6)

### Example 3

In the present example, a backlight was prepared as in Example 1. The backlight of the present example has a configuration similar to that of the backlight of Example 1 except that the configuration of the top film layer is different from the configuration of the top film layer of Example 1. The top film layer of the present example includes a nonwoven fabric in which two layers of nonwoven fabric (EFD-D2-85) are stacked.

In the present example, the uniformity and luminance of the surface of the backlight were evaluated in the same manner as in Example 1. In addition, in the present example, the effective transmittance (gain) and the haze value were measured in the same manner as in Example 2.

### Comparative Example 3

In the present comparative example, a backlight was prepared in the same manner as in Example 1. The backlight of the present comparative example has the same configuration as the backlight of Example 1 except that the configuration of the top film layer is different from the configuration of the top film layer of Example 1. The top film layer of the present comparative example includes nonwoven fabric having a basis weight of 50 g/m².

In the present example, the uniformity and luminance of the surface of the backlight were evaluated in the same manner as in Example 1. In addition, in the present comparative example, the effective transmittance (gain) and the haze value were measured in the same manner as in Example 2.

Table 2 is a table showing the backlight configurations and the measurement results for the effective transmittance (gain) and the haze value of the nonwoven fabric in Example 2, Example 3, and Comparative Example 3.

TABLE 2

| | Example 2 | Example 3 | Comparative Example 3 |
|---|---|---|---|
| Top film layer | Reflective polarizer | Reflective polarizer | Reflective polarizer |
| | (DBEF-Qv2) | (DBEF-Qv2) | (DBEF-Qv2) |
| | Nonwoven fabric | 2 stacked nonwoven fabric | Nonwoven fabric |
| | (EFD-D2-85) | (EFD-D2-85) | (Basis Weight: 50 g/m²) |
| Effective | 0.92 | 0.82 | 0.98 |
| transmittance | | | |
| Haze value | 98.54 | 98.74 | 97.15 |

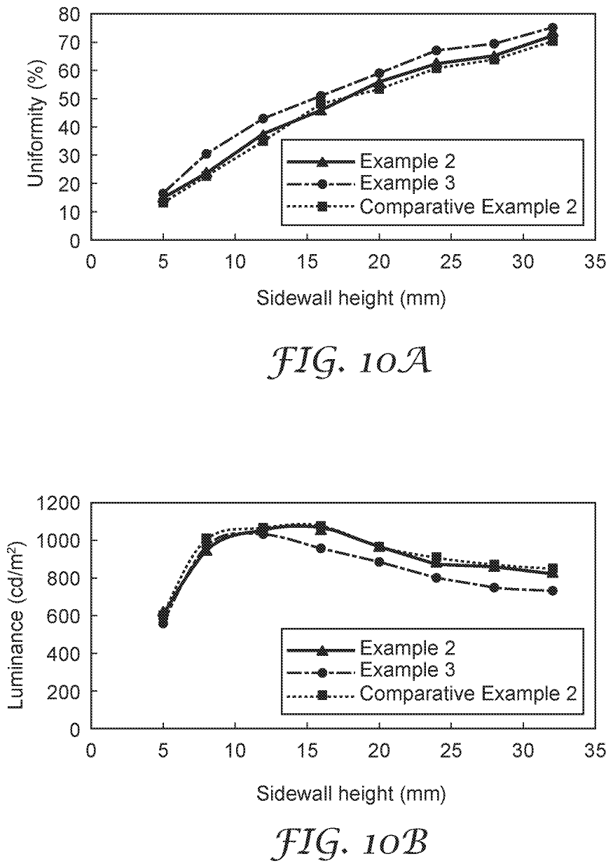

FIG. 10A is a diagram illustrating the relationship between the height of the side walls and the uniformity of the surface of the backlight 1 in Example 2, Example 3, and Comparative Example 3. FIG. 10B is a diagram illustrating the relationship between the height of the side walls and the luminance of the surface of the backlight in Example 2, Example 3, and Comparative Example 3.

Table 3 is a table showing the relationship between the height of the side walls and the observation results of the hot spots in Example 2, Example 3, and Comparative Example 3.

TABLE 3

| Sidewall height | Example 2 | Example 3 | Comparative Example 3 |
|---|---|---|---|
| (mm) | Hot spot | Hot spot | Hot spot |
| 5 | A | A | B |
| 8 | A | A | B |
| 12 | A | A | B |
| 16 | A | A | B |
| 20 | A | A | B |
| 24 | A | A | B |
| 28 | A | A | B |
| 32 | A | A | B |

### Example 4

### Manufacturing of Curved Backlight

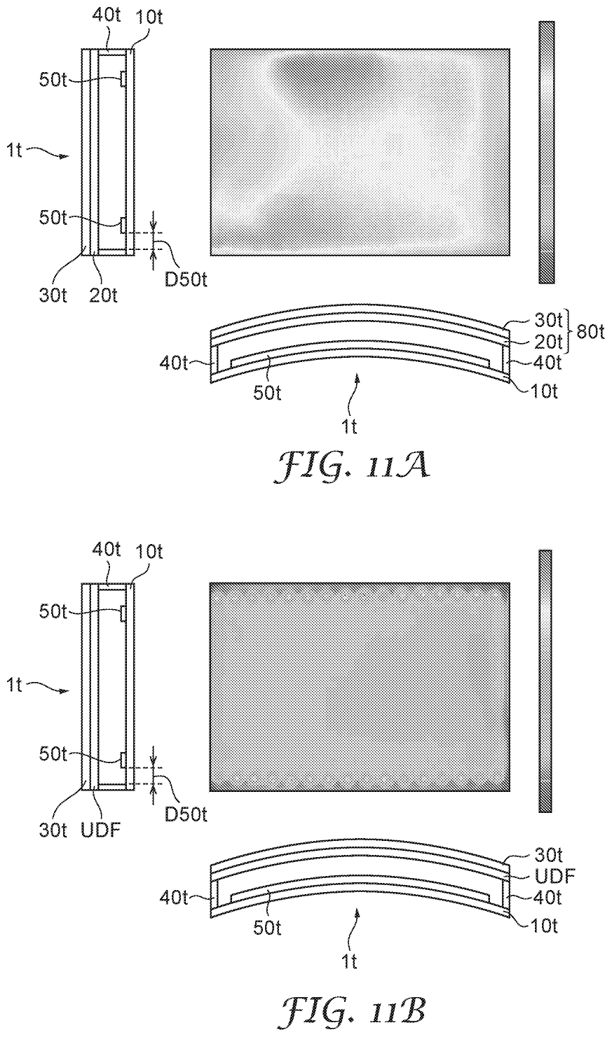

As illustrated in FIG. 11A, in the present example, a backlight It was manufactured as the backlight It that is curved when viewed as a cross-section in a direction intersecting the nonwoven fabric. Initially, two curved magnetic sign holders (Magnet curved sign holder manufactured by Smile Corp) were prepared. These sign holders both have a B5 size (176 mm×250 mm) and are curved with a radius of curvature 800 mm.

Next, a high reflection film ESR-80v2 (manufactured by 3M) was adhered to the surface of one sign holder. The size of the high reflection film ESR-80v2 was configured to be the same as the size of the sign holder. The sign holder to which the high reflection film ESR-80v2 was adhered was formed as a reflecting portion 10t.

Next, two long sides of the reflective polarizer DBEF-Qv2 (manufactured by 3M) were pasted to the surface of the other sign holder. A double coated tape was used for this pasting. After the pasting, the nonwoven fabric EFD-D2-85 (manufactured by 3M) was fixed with a double coated tape on the side of the reflective polarizer DBEF-Qv2 not pasted to the sign holder. The sign holder including the nonwoven fabric 20t and the reflective polarizer 30t was formed as a top film layer 80t.

Next, two flexible 1865 type side view tape LEDs (manufactured by Amon Industry) were prepared. The side view tape LEDs have a length of 30 cm and include 12 LEDs per tape. The drive voltage is 12 V.

Next, the side view tape LEDs were fixed on the high reflection film ESR-80v2 of one sign holder (reflecting portion 10t) to form the light source 50t. One side view tape LED was fixed along one long side of the sign holder and the other side view tape LED was fixed along the other long side of the sign holder.

Next, 12 neodymium magnets NK019 (manufactured by Niroku Seisakusho) were prepared. The neodymium magnet NK019 has a size of 5 mm×5 mm×5 mm. One sign holder (the reflecting portion 10t) and the other sign holder (the top film layer 80t) were joined by the neodymium magnets. Specifically, three magnets were stacked in each corner of one sign holder and then the other sign holder (the top film layer 80t) was joined by the magnetic force. The distance between one sign holder (the reflecting portion 10t) and the other sign holder (the top film layer 80t) was 15 mm.

Next, a high reflection film ESR-80v2 (manufactured by 3M) was pasted covering the four side surface portions constituted by one sign holder (the reflecting portion) and the other sign holder (the top film layer) using the double coated tape. The neodymium magnet NK019 and the high reflection film ESR-80v2 constitute a side wall 40t. The high reflection film ESR-80v2 was installed reflecting light from the light source 50t to inside the curved backlight 1t. The distance D50t from the light source 50t to the side wall 40t was 5 mm. A cavity is formed in the side wall 40t, and the light source 50t has a function to irradiate light into the cavity.

### (Measurement of Luminance)

In the present example, luminance of the backlight surface was evaluated in the same manner as in Example 1. However, when observing the surface of the backlight, the observed image was divided into 15. Specifically, the division was made into three divisions along a direction of one side (the short side direction) of the surface of the backlight, and the division was also made into five divisions along the direction of the other side (the long side direction) intersecting the above direction. The luminance at the center point of each of the 15 divided areas was measured.

### Comparative Example 4

In the present comparative example, a backlight similar to that of Example 4 was manufactured except that the top film layer used the diffusion sheet UDF2-50 (manufactured by 3M) (indicated as UDF in FIG. 11B) instead of the nonwoven fabric EFD-D2-85 (manufactured by 3M). The diffusion sheet UDF2-50 does not have a non-woven fabric configuration. In the present comparative example, the luminance of the backlight surface was evaluated in the same manner as in Example 1.

FIG. 11A is a diagram illustrating an observed image with which the luminance of the surface of the backlight according to Example 4 was observed. FIG. 11B is a diagram illustrating an observed image with which the luminance of the surface of the backlight of Comparative Example 4 was observed. In FIGS. 11A and 11B, the shape of the backlight was appended beside the observed image with which the luminance was observed. No hot spots deriving from the LED were observed in the backlight in Example 4. On the other hand, in the backlight of Comparative Example 4, hot spots deriving from LED were observed.

Table 4 is a table showing the backlight configurations and the hot spot evaluation results for Example 4 and Comparative Example 4.

TABLE 4

| | Example 4 | Comparative Example 4 |
|---|---|---|
| Top film layer | Reflective polarizer | Reflective polarizer |
| | (DBEF-Qv2) | (DBEF-Qv2) |
| | Nonwoven fabric | Diffusion sheet |
| | (EFD-D2-85) | (UDF2-50) |
| Hot spot | A | B |

### Example 5

In the present example, the backlight was manufactured in the same manner as in Example 1 with the exception that in the top film layer, the prism sheet 60 was provided between the nonwoven fabric 20 and the reflective polarization portion 30. In the present example, the height of the side wall was configured to be 15 mm.

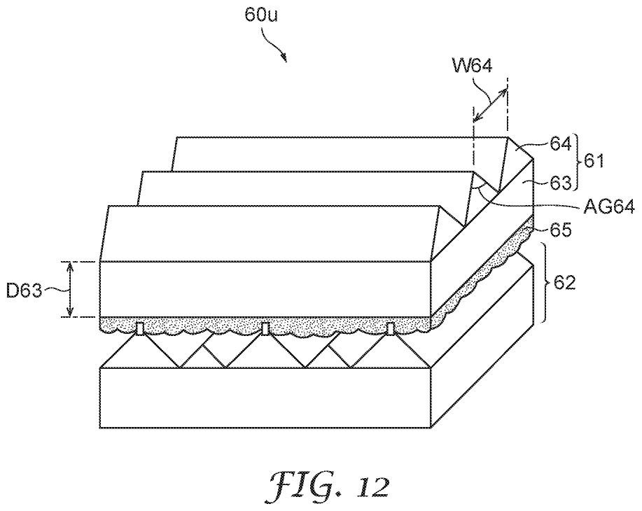

FIG. 12 is a schematic view illustrating a structure of the prism sheet according to Example 5. In the present example, an advanced structured optical composite ASOC3-106(24) (manufactured by 3M) was used as the prism sheet 60u. The prism sheet 60u includes the upper prism layer 61 as the upper polymer layer and the lower prism layer 62 as the lower polymer layer, and the lower prism layer 62 is located below the upper prism layer 61. The lower prism layer 62 is located closer to the nonwoven fabric 20 than the upper prism layer 61, and the upper prism layer 61 is located closer to the reflective polarization portion 30 side than the lower prism layer 62.

The upper prism layer 61 includes a substrate film 63 and a prism array 64 provided on the substrate film 63. The substrate film 63 includes a polyester film. The polyester film had a thickness D63 of 36 μm. In the prism array 64, a single prism extends in one direction, and a plurality of other prisms are arranged in the other direction substantially orthogonal to the one direction. The prism array 64 included a non-halogenated acrylic resin, and the prism angle AG64 in the prism array 64 was 90 degrees. The spacing W64 between the top of one prism and the top of the other prism adjacent in the other direction was 24 μm.

The lower prism layer 62 had the same structure and material as the upper prism layer 61 and the lower prism layer 62 was bonded to the upper prism layer 61 by the adhesive layer 65. The adhesive layer 65 was a diffusion adhesive. The top of the prism sheet of the lower prism layer 62 was bonded to the bottom surface of the substrate film 63 of the upper prism layer 61 with a diffusion adhesive.

### (Measurement of Luminance)

In the present example, luminance of the backlight surface was evaluated in the same manner as in Example 1.

### Example 6

In the present example, a backlight was manufactured in the same manner as in Example 1 with the exception that in the top film layer, a prism sheet was provided between the nonwoven fabric and the reflective polarizing portion. In the present example, the height of the side wall was configured to be 15 mm.

The prism sheet of the present example includes only the lower prism layer 62 of the advanced structured optical composite ASOC3-106(24) (manufactured by 3M) illustrated in FIG. 12.

### (Measurement of Luminance)

In the present example, luminance of the backlight surface was evaluated in the same manner as in Example 1.

### Example 7

In the present example, a backlight was manufactured in the same manner as in Example 1. In the present example, the height of the side wall was configured to be 15 mm. In the present example, luminance of the backlight surface was evaluated in the same manner as in Example 1.

Table 5 is a table showing the configurations of a backlight in Examples 5 to 7.

TABLE 5

| | Example 5 | Example 6 | Example 7 |
|---|---|---|---|
| Top film layer | Reflective polarizer | Reflective polarizer | Reflective polarizer |
| | (RPM) | (RPM) | (RPM) |
| | Advanced structured | Lower prism layer of | — |
| | optical composite | advanced structured optical | |
| | ASOC3-106(24) | composite ASOC3-106(24) | |
| | Nonwoven fabric | Nonwoven fabric | Nonwoven fabric |
| | (EFD-D2-85) | (EFD-D2-85) | (EFD-D2-85) |

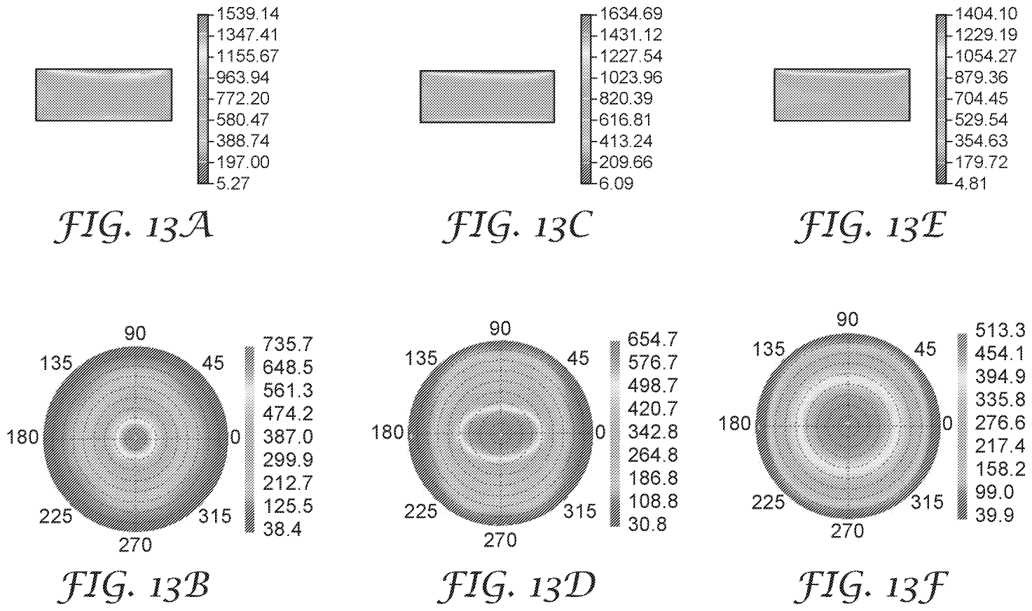

FIGS. 13A and 13B are diagrams illustrating the surface luminance distribution and the angular luminance distribution of the backlight surface in Example 5, respectively. FIGS. 13C and 13D are, respectively, diagrams illustrating the surface luminance distribution and the angular luminance distribution of the backlight surface in Example 6. FIGS. 13E and 13F are, respectively, diagrams illustrating the surface luminance distribution and the angular luminance distribution of the backlight surface in Example 7.

High uniformity and luminance were obtained in Example 5, Example 6, and Example 7, as illustrated in the diagrams of the surface luminance distributions of FIGS. 13A, 13C, and 13E. In addition, as illustrated in the diagrams of the angular luminance distributions of FIGS. 13B, 13D, and 13F, in particular, in Examples 5 and 6, the luminance of the backlight in the front direction increased. When Example 5 and Example 6 are compared, the luminance of the backlight in the front direction was higher in Example 5 compared to Example 6.

### REFERENCE SIGNS LIST

1 Backlight, 5 Light emitting surface, 20 Nonwoven fabric, 30 Reflective polarizing portion, 40 Side wall, 50 Light source, 60 Prism sheet, 70 Cavity, LPD1 Liquid crystal display device, and Lx1 Optical axis.

1. A backlight comprising:
a reflecting portion;
a nonwoven fabric disposed opposing the reflecting portion;
a reflective polarization portion disposed along a surface of the nonwoven fabric opposite to the surface of the nonwoven fabric opposing the reflecting portion;
a side wall surrounding a cavity formed between the reflecting portion and the nonwoven fabric; and
a light source disposed proximate the side wall and configured to illuminate light in the cavity; wherein
a haze value of the nonwoven fabric is 90% or greater, an effective transmittance of the nonwoven fabric is 0.8 or greater, and a basis weight of the nonwoven fabric is 60 g/m² or greater.

2. The backlight according to claim 1, wherein at least a portion of the backlight is curved when viewed as a cross-section in a direction intersecting the nonwoven fabric.

3. The backlight according to claim 1, wherein
the cavity has a flat shape, and
in the cavity, when a most distant first distance out of distances between the reflecting portion and the nonwoven fabric is set as H, and when a second distance is a distance along the reflecting portion and the second distance between the side wall portion proximate to which the light source is disposed and the side wall portion opposing the light source is set as Dp,
Dp/H is from 3 to 25.

4. The backlight according to claim 1, wherein
the cavity has a flat shape,
the cavity comprises the plurality of light sources disposed opposing to each other in the optical axis direction, and
in the cavity, when a most distant first distance out of distances between the reflecting portion and the nonwoven fabric is set as H, and when a second distance is a distance along the reflecting portion and the second distance between the side wall portion proximate to which one of the light source is disposed and the side wall portion proximate to which the other of the light source is disposed is set as Dq, Dq/H is from 6 to 50.

5. The backlight according to claim 1, wherein the reflecting portion includes a mirrored surface on the cavity side.

6. The backlight according to claim 1, wherein the side wall comprises an opposing surface opposing the light source, and
at least a portion of the opposing surface is a mirrored surface.

7. The backlight according to claim 1, wherein, in the cavity, a distance between the reflecting portion and the nonwoven fabric is substantially constant.

8. The backlight according to claim 1, wherein the nonwoven fabric and the reflective polarization portion are bonded together.

9. The backlight according to claim 1, further comprising a prism sheet disposed between the nonwoven fabric and the reflective polarization portion, wherein the prism sheet is bonded to the nonwoven fabric.

10. A liquid crystal display device comprising: the backlight according to claim 1, and a liquid crystal panel disposed on a light emitting surface side of the backlight.

11. The liquid crystal display device according to claim 10, wherein the backlight is bonded to the liquid crystal panel.
